(19) United States
(12) Patent Application Publication
(10) Pub. No.: US 2026/0204437 A1
(43) Pub. Date: Jul. 16, 2026

(54) DIFFUSION PUMP

(71) Applicants: Kyoto Fusioneering Ltd., Tokyo (JP); Kyoto University, Kyoto (JP)

(72) Inventors: Satoshi KONISHI, Kyoto (JP); Juro YAGI, Kyoto (JP); Yoshifumi KUME, Tokyo (JP); Yoshinao MATSUNAGA, Tokyo (JP)

(21) Appl. No.: 19/555,808

(22) Filed: Mar. 3, 2026

Related U.S. Application Data
(63) Continuation of application No. PCT/JP2024/032380, filed on Sep. 10, 2024.

(30) Foreign Application Priority Data
Sep. 11, 2023 (JP) 2023-147143

(51) Int. Cl. G21B 1/17

(52) U.S. Cl. CPC G21B 1/17

(57) ABSTRACT

A diffusion pump 1 includes a casing 11; a jet body 12 which is installed inside the casing 11; an intake port 13 which is installed at an upper portion of the casing 11 and connected to a vacuum vessel; an exhaust port 14 which is installed at a lower portion of the casing 11; a working fluid reservoir 15 which is installed at a bottom portion of the casing 11 and stores a working fluid; a jet nozzle 17 which ejects vapor of the working fluid, which is heated by a heater and thereby evaporated, in a direction including a component in a direction toward the bottom portion of the casing 11; and a temperature adjustment pipe 18 which is installed to surround the casing 11. The working fluid is an alkali metal or a low-boiling-point liquid metal.

The contents of the following patent application(s) are incorporated herein by reference:

NO. 2023-147143 filed in JP on September 11, 2023

NO. PCT/JP2024/032380 filed in WO on September 10, 2024.

### BACKGROUND

### 1. TECHNICAL FIELD

The present invention relates to a diffusion pump.

### 2. RELATED ART

A diffusion pump, which is a type of vacuum pump used in a vacuum vessel or the like, uses a high-speed jet stream ejected from a nozzle to impart momentum to gas molecules flowing in through an intake port, thereby discharging the gas molecules through an exhaust port (See, for example, Patent Document 1). Such a jet stream is usually formed of vapor of oils and fats or the like.

### RELATED ART DOCUMENT

### Patent Document

Patent Document 1: Japanese Patent Application Publication No. 2005-180242

### BRIEF DESCRIPTION OF THE DRAWINGS

FIG. 1 is a cross-sectional view of a diffusion pump according to a first embodiment.

FIG. 2 is a cross-sectional view of a diffusion pump according to a second embodiment.

FIG. 3 is a cross-sectional view of a diffusion pump according to a third embodiment.

FIG. 4 is a cross-sectional view of a diffusion pump according to a fourth to eighth embodiments.

### DESCRIPTION OF EXEMPLARY EMBODIMENTS

Hereinafter, the present invention will be described based on preferred embodiments with reference to the drawings. In the embodiments and modifications, same or equivalent components and members are denoted by same reference numerals, and redundant description is omitted as appropriate. In addition, dimensions of members in each drawing are appropriately enlarged and reduced in order to facilitate understanding. In addition, in each drawing, some of members that are not important for describing the embodiment are omitted from illustration. In addition, terms including ordinal numbers such as first and second are used to describe various components, but the terms are used only for purpose of distinguishing one component from other components, and the components are not limited by the terms. A nuclear fusion reactor generate power by converting a mixed fuel gas containing deuterium and tritium into plasma within a vacuum vessel for nuclear combustion, and extracting energy generated by a nuclear fusion reaction. At this time, an exhaust gas after being used in the nuclear fusion reaction contains radioactive tritium that has not been consumed. Therefore, a special requirement is imposed on the vacuum pump that exhausts the gas. In the nuclear fusion reactor, in addition to the exhaust of the plasma, a vacuum pump is required to handle a gas containing a high concentration of tritium, and a similar requirement is also imposed on this. An existing vacuum exhaust device is difficult to satisfy such a condition. Since radioactive tritium is an isotope of hydrogen, in a pump using an organic substance such as oils and fats, the tritium substitutes for hydrogen in a compound to become a radioactive contamination source. In addition, since tritium causes radiolysis of an organic substance, a pump for exhausting that needs to be composed of a completely inorganic material such as metal or ceramics. Therefore, it is not possible to use an oil rotary pump or a Roots blower using oils and fats for bearing or lubrication, or an oil diffusion pump using oils and fats for working liquid. In a turbo molecular pump, an induced current is induced when a conductive metal rotor moves in a magnetic field. In addition, when metal vapor or mist exists in the exhaust gas, the metal vapor or mist adheres to an exhaust blade. Therefore, there is a problem that the turbo molecular pump cannot be used in a vicinity of a core of a magnetic confinement fusion device. A cryopump is not suitable for continuous exhaust since a discharge target gas is condensed on a cooling surface, and there is a problem that tritium inventory becomes excessive. In a nuclear fusion device, there is a concept that an inner surface of a plasma vessel is protected from plasma particles, neutrons, and heat by covering, with a liquid metal, an inner surface of a space in which plasma is generated. In this case, the exhaust target gas includes metal vapor and metal mist. It is known that a mechanical pump is difficult to use since liquid or solidified metal adheres to a movable portion to obstruct its movement. On the other hand, conventionally, there is also an idea of using a diffusion pump using mercury as a working fluid. However, currently, due to problems of chemical toxicity and environmental pollution, mercury cannot be produced, used, and finally discarded. Even when used, the tritium-containing exhaust gas is often subsequently treated using various catalysts. However, it is known that most of these catalysts are poisoned by mercury. From the above, a diffusion pump is required which does not use oils and fats or mercury as the working fluid. The present disclosure has been made in view of such problems, and an object thereof is to provide a diffusion pump having a working fluid that replaces oils and fats and mercury.

### First embodiment

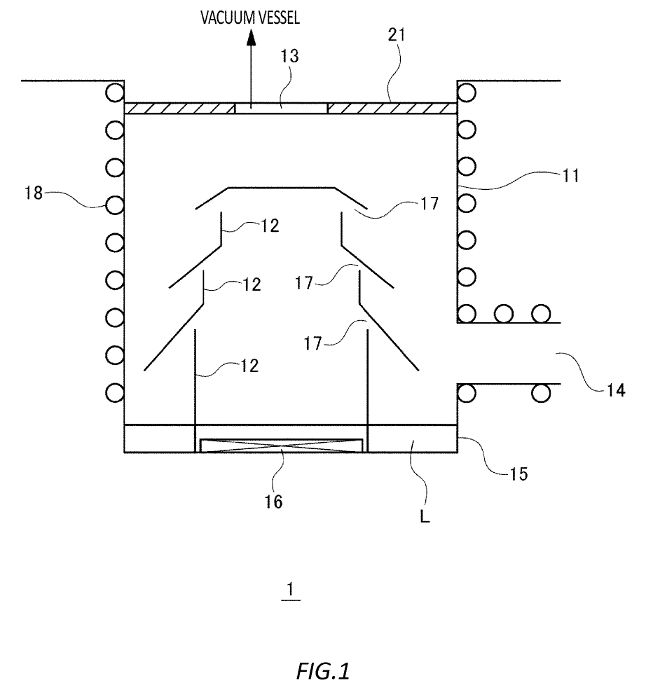

Hereinafter, a preferred embodiment of the present disclosure will be described with reference to FIGS. 1 to 3. FIG. 1 is a cross-sectional view of a diffusion pump 1 according to a first embodiment. The diffusion pump 1 generates a vacuum in a vacuum vessel. The diffusion pump 1 includes a casing 11, a jet body 12 which is installed inside the casing 11, an intake port 13 which is installed at an upper portion of the casing 11 and connected to a vacuum vessel, an exhaust port 14 which is installed at a lower portion of the casing 11, a working fluid reservoir 15 which is installed at a bottom portion of the casing 11, a jet nozzle 17 which ejects vapor of a working fluid L, which is heated by a base heater 16 installed at a bottom portion of the working fluid reservoir 15 and thereby evaporated, in a downward direction in the drawing, and a temperature adjustment pipe 18 which is installed to surround the casing 11. The working fluid L is an alkali metal or a liquid metal having a relatively low boiling point. A jet stream of the diffusion pump according to the present embodiment can be directed in any direction as long as the jet stream can be finally guided as a liquid to the working fluid reservoir 15 at the lower portion of the casing.

The casing 11 is typically cylindrical, but may have any shape such as a rectangular parallelepiped having a cross section illustrated in the drawing. The casing 11 airtightly houses the jet body 12, the working fluid reservoir 15, and the like therein. The intake port 13 is provided at an upper portion (typically, an upper end) of the casing 11. The exhaust port 14 is provided at a lower portion of the casing 11 (typically, a lower side surface of the casing 11). In particular, in order to prevent back-diffusion of the vapor of the working fluid L that may occur during non-steady-state operation such as upon startup or shutdown of the diffusion pump 1, a baffle 21 for preventing the vapor of the working liquid from flowing back into the intake port 13 may be selectively provided at the upper end of the casing 11.

The jet body 12 is also called a chimney, and is constituted by a plurality of nozzles such as concentric cylinders or rectangular parallelepipeds having a cross section illustrated in the drawing. Three jet bodies 12 are illustrated in FIGS. 1 to 3. The jet nozzles 17 which are tapered are formed at upper ends of the jet bodies 12. Each of these jet nozzles 17 is oriented downward in the casing 11. Each of the jet nozzles 17 is configured such that a gap between the jet nozzle 17 and an inner wall of the casing 11 gradually decreases toward a lower side of FIGS. 1 to 3.

The working fluid reservoir 15 stores liquid as a working fluid. As will be described in detail later, this working fluid L is a liquid alkali metal or a low-boiling-point metal. The base heater 16 is installed at the bottom portion of the working fluid reservoir 15. The base heater 16 heats the working fluid L within the working fluid reservoir 15.

The temperature adjustment pipe 18 is installed to surround the casing 11. The temperature adjustment pipe 18 is, for example, a circular pipe that spirally surrounds the casing 11. Usually, the temperature adjustment pipe 18 operates as a cooling device in which a coolant circulates to cool an inner wall side surface of the casing 11 during operation of the diffusion pump 1. However, as will be described later, since a boiling point of alkali metal or liquid metal as a working medium is relatively higher than a room temperature or an ambient temperature, the temperature adjustment pipe 18 is configured to operate as a heating device particularly upon startup of the diffusion pump 1.

The above is a configuration of the diffusion pump 1. Next, operation of the diffusion pump 1 will be described. The working fluid L stored at the bottom of the working fluid reservoir 15 is heated by the base heater 16 and thereby evaporated. The vapor of the working fluid L rises in a central portion of the jet body 12, and then is ejected from each jet nozzle 17 toward a lower side (that is, in an exhaust direction). Since an inside of the casing 11 is exhausted by a low-vacuum pump (not illustrated) installed on an exhaust side, the vapor of the working fluid L is accelerated to approximately a speed of sound (several hundred meters per second or more). Gas molecules within the vacuum vessel introduced into the casing 11 through the intake port 13 is imparted with momentum in a flow direction of the vapor by colliding with the vapor accelerated to approximately the speed of sound. As a result, the gas flows to the exhaust side and is discharged from the exhaust port 14. In this process, since a space between each jet nozzle 17 and the inner wall of the casing 11 gradually narrows, a negative pressure is formed in the intake port 13 by a pump action, so that exhaust is performed extremely efficiently. When a residual gas within the vacuum vessel is exhausted in this manner, a vacuum is generated in the vacuum vessel.

On the other hand, the vapor of the working fluid L collides with the inner wall of the casing 11 and is cooled by heat exchange with the temperature adjustment pipe 18, whereby condensation occurs on the inner wall of the casing 11. The condensed working fluid L falls down or flows down on a wall surface, and is recovered as a liquid working fluid in the working fluid reservoir 15.

The diffusion pump of the present embodiment uses an alkali metal or a low-boiling-point liquid metal as the working fluid. This alkali metal, such as lithium, sodium, potassium, and alloys thereof, may be suitable in terms of melting point and vapor pressure. The diffusion pump of the present embodiment has a structure similar to that of a diffusion pump using oils and fats or mercury vapor, but has technical features in a heating method and temperature distribution control, unlike oils and fats or mercury which are liquid at a normal temperature. In particular, there are various modifications in terms of not only performing heating and evaporation of metal as a working fluid at a high temperature but also appropriate temperature distribution setting and heating/cooling design necessary for condensation and liquefaction, circulation reuse, and the like for the metal, and the like.

According to the present embodiment, it is possible to provide a diffusion pump having a working fluid that replaces oils and fats or mercury. According to the present embodiment, it is possible to achieve a diffusion pump using an alkali metal or a low-boiling-point liquid metal as a working fluid instead of conventional oils and fats and mercury. This diffusion pump does not use mercury that may poison a tritium catalyst provided at a subsequent stage in the exhaust of gas, and does not contain an organic substance that may be decomposed by radiation of tritium in a case of exhausting gas containing a radioactive substance such as tritium. Accordingly, a residual gas, which contains tritium, existing particularly in the nuclear fusion reactor can be safely exhausted from the vacuum vessel.

### Second embodiment

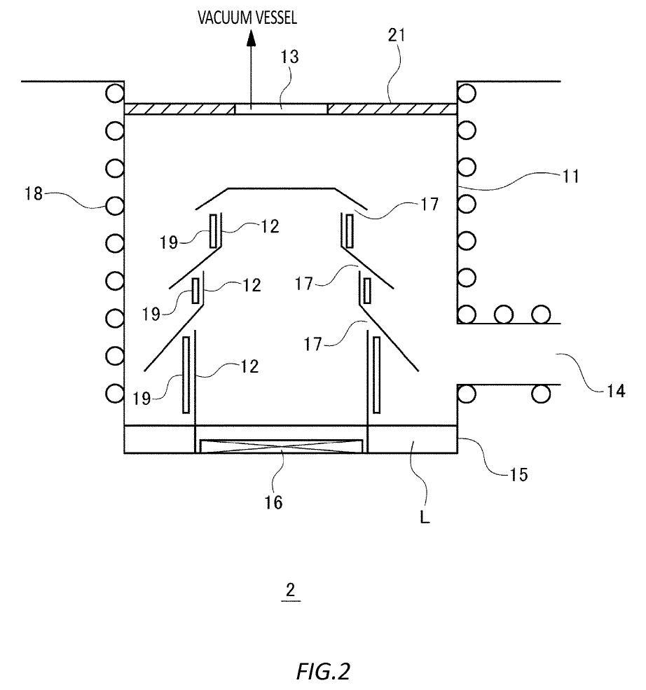

FIG. 2 is a cross-sectional view of a diffusion pump 2 according to a second embodiment. The diffusion pump 2 includes the casing 11, the jet body 12 which is installed inside the casing 11, the intake port 13 which is installed at the upper portion of the casing 11 and connected to the vacuum vessel, the exhaust port 14 which is installed at the lower portion of the casing 11, the working fluid reservoir 15 which is installed at the bottom portion of the casing 11, the jet nozzle 17 which ejects the vapor of the working fluid L, which is heated by the base heater 16 installed at the bottom portion of the working fluid reservoir 15 and thereby evaporated, in the downward direction, the temperature adjustment pipe 18 which is installed to surround the casing 11, and a side heater 19 which is installed on an outer wall of the jet body 12. That is, the diffusion pump 2 includes the side heater 19 in addition to the configuration of the diffusion pump 1 of FIG. 1. Other configuration of the diffusion pump 2 is common to the configuration of the diffusion pump 1.

The side heater 19 additionally heats the vapor of the working fluid L heated by the base heater 16 and thereby evaporated. Accordingly, it is possible to efficiently heat an alkali metal having a high boiling point or a liquid metal thereof to generate a jet.

### Third embodiment

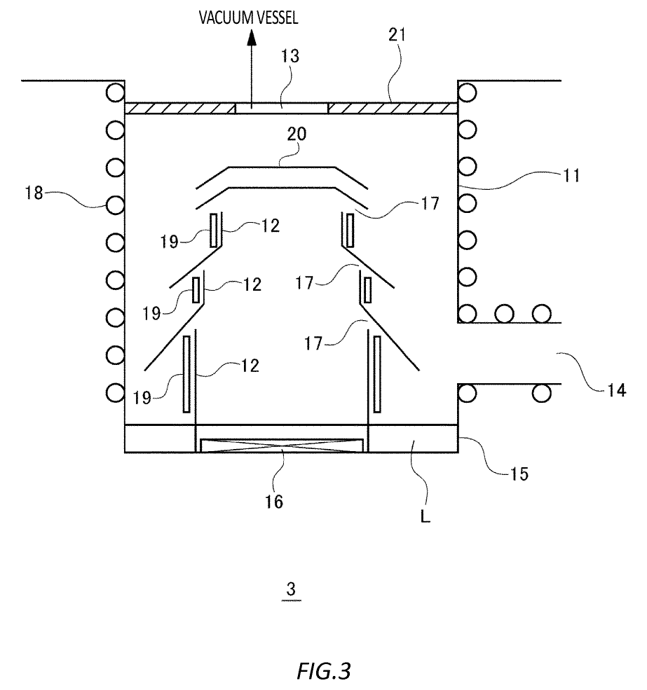

FIG. 3 is a cross-sectional view of a diffusion pump 3 according to a third embodiment. The diffusion pump 3 includes the casing 11, the jet body 12 which is installed inside the casing 11, the intake port 13 which is installed at the upper portion of the casing 11 and connected to the vacuum vessel, the exhaust port 14 which is installed at the lower portion of the casing 11, the working fluid reservoir 15 which is installed at the bottom portion of the casing 11, the jet nozzle 17 which ejects the vapor of the working fluid L, which is heated by the base heater 16 installed at the bottom portion of the working fluid reservoir 15 and thereby evaporated, in the downward direction, the temperature adjustment pipe 18 which is installed to surround the casing 11, the side heater 19 which is installed on the outer wall of the jet body 12, and a thermal insulator 20 which is installed above the jet body 12. That is, the diffusion pump 3 includes the thermal insulator 20 in addition to the configuration of the diffusion pump 2 in FIG. 2. Other configuration of the diffusion pump 3 is common to the configuration of the diffusion pump 2.

The thermal insulator 20 retains heat of the vapor of the working fluid heated by the base heater 16 and the side heater 19. Accordingly, it is possible to prevent the above-described temperature decrease of the alkali metal or liquid metal having a boiling point higher than that of oil, so that the jet can be generated more efficiently.

Note that the diffusion pump 3 of this example includes both the side heater 19 and the thermal insulator 20. However, the present invention is not limited thereto, and a configuration including only the thermal insulator 20 is also possible and useful.

### Fourth embodiment

A diffusion pump of a fourth embodiment is any of the above-described diffusion pumps, and the temperature adjustment pipe 18 is switchable between a cooling pipe and a heating pipe.

According to the present embodiment, the temperature adjustment pipe 18 can be operated as a cooling device that cools an inner wall side surface of the casing 11 to liquefy the vapor of the working fluid during operation, and can also be operated as a heating device upon startup.

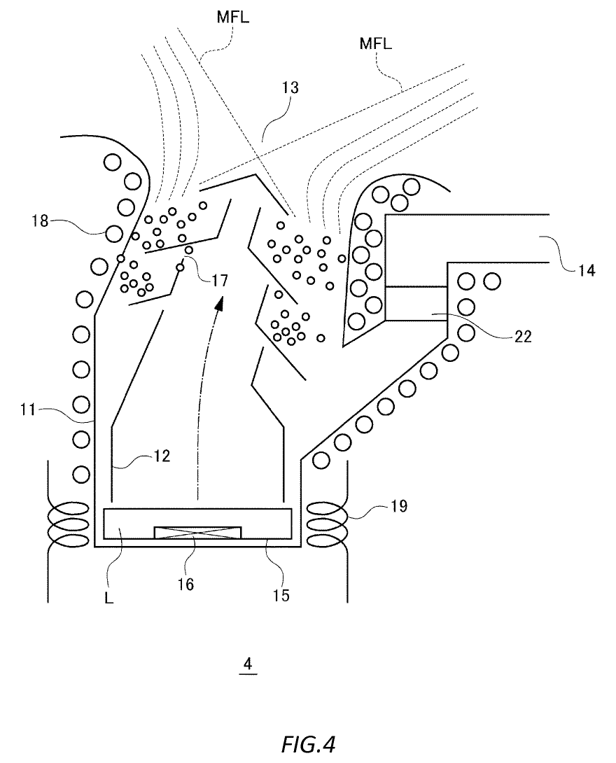

Hereinafter, another preferred embodiment of the present disclosure will be described with reference to FIG. 4. FIG. 4 is a cross-sectional view of a diffusion pump 4 according to fifth to eighth embodiments. The diffusion pump 4 generates a vacuum in the vacuum vessel. The diffusion pump 4 includes the casing 11, the jet body 12 which is installed inside the casing 11, the intake port 13 which is installed at the upper portion of the casing 11 and connected to the vacuum vessel, the exhaust port 14 which is installed at the lower portion of the casing 11, the working fluid reservoir 15 which is installed at the bottom portion of the casing 11, the jet nozzle 17 which ejects the vapor of the working fluid L, which is heated by the base heater 16 installed at the bottom portion of the working fluid reservoir 15 and thereby evaporated, in the downward direction, and the temperature adjustment pipe 18 which is installed to surround the casing 11. The working fluid L is an alkali metal or a liquid metal. The diffusion pump 4 may include the side heater 19 or a gas-liquid separator 22 selectively.

The diffusion pump 4 is similar to the diffusion pumps 1 to 3 in FIGS. 1 to 3, but has a distinctive feature in that it is installed inside a vacuum vessel. FIG. 4 illustrates, as a special example, the diffusion pump 4 installed inside (specifically, at the lower portion of) the vacuum vessel of the nuclear fusion reactor. Two intersecting broken lines MFL indicate magnetic field lines in the nuclear fusion reactor. That is, the diffusion pump 4 is disposed immediately below the magnetic field lines MFL in the nuclear fusion reactor. The casing 11 is common to a part of the vacuum vessel. Other configuration and operation of the diffusion pump 4 are common to the configurations of the diffusion pumps 1 to 3.

The working fluid L stored at the bottom of the working fluid reservoir 15 is heated by the base heater 16 and the side heater 19 and thereby evaporated. The vapor of the working fluid L rises in the central portion of the jet body 12, and then is ejected from each jet nozzle 17 toward the lower side (that is, in the exhaust direction). Since the inside of the casing 11 is exhausted to a low vacuum, the vapor of the working fluid L is accelerated to approximately the speed of sound (several hundred meters per second or more). Gas molecules within the vacuum vessel introduced into the casing 11 through the intake port 13 is imparted with momentum in the flow direction of the vapor by colliding with the vapor accelerated to approximately the speed of sound. As a result, the gas flows to the exhaust side and is discharged from the exhaust port 14. In this process, compression is performed between each jet nozzle 17 and the inner wall of the casing 11, and a negative pressure is formed in the intake port 13 by the pump action, so that exhaust is performed extremely efficiently. When a residual gas within the vacuum vessel is exhausted in this manner, a vacuum is generated in the vacuum vessel.

### Fifth embodiment

The diffusion pump 4 of a fifth embodiment includes a recovery mechanism for thermal energy held by gas within the vacuum vessel. For thermal energy recovery, a temperature adjustment pipe may be used, or a dedicated thermal energy recovery device may be provided outside.

Exhaust of plasma is initially in an ultrahigh temperature state ranging from tens of thousands to hundreds of millions of degrees. Plasma particles gradually lose energy due to collision with gas particles, a series of excitation phenomena called an atomic and molecular process, and the like, and are finally exhausted as gas at the normal temperature. In this process, thermal energy held by the plasma is transferred from the alkali metal vapor, which is the diffusion pump working fluid, to a heat medium of the casing 11 or the temperature adjustment pipe 18.

When a temperature of the working fluid L ejected from the jet nozzle 17 is approximately 100°C or lower, heat may be discarded to an external environment without being used as waste heat. However, the heat held by the alkali metal working fluid L according to the present embodiment during cooling reaches 100°C or higher in a case of sodium, and 300°C or higher in a case of lithium. This can be used for thermal energy for power generation or the like. Most of the energy generated in the nuclear fusion reaction is transferred to a blanket as kinetic energy of neutrons. However, 20% to 40% of the kinetic energy is lost as helium alpha particles that are plasma exhaust. Further, the plasma particles also hold energy for heating and maintaining the plasma. Therefore, recovery of these energies greatly contributes to improvement in energy balance of the nuclear fusion reactor, increase in amount of power generation through energy utilization, and improvement in energy conversion efficiency of an entire plant and reduction in power generation cost.

### Sixth embodiment

In a sixth embodiment, the gas within the vacuum vessel includes vapor or mist of liquid metal or powdery solid debris. The working fluid L has an affinity for such vapor or mist of liquid metal or powdery solid debris.

In a magnetic field confinement type fusion device, there is a concept that a liquid metal is installed on a divertor surface to avoid material wear that is inevitable for a solid material blanket. In this case, the exhaust gas from the plasma illustrated in FIG. 4 includes vapor from evaporation of the liquid metal and mist from condensation of the vapor. Further, it is common for a target chamber of an inertial confinement type fusion device using a laser or a particle beam to have a liquid metal on its inner surface. Further, also in a reactor such as a magnetized target compression type fusion device or a collision type fusion device, plasma is surrounded by a liquid metal.

According to the present embodiment, these vapor or mist of liquid metal or powdery solid debris are exhausted by the diffusion pump 4 and does not return into the vacuum vessel. Further, since the working fluid L has an affinity for these vapor or mist of liquid metal or powdery solid debris, these substances are incorporated into the working fluid L. By appropriately extracting this from a working fluid loop, the entire device can be stably operated. In particular, in an inertial confinement device in which a frequency of pulse operation is important from a viewpoint of economic efficiency, rapid exhaust from a plasma chamber becomes possible.

Note that a part of the working fluid L leaks to the exhaust port 14. Therefore, by separating the liquid of the working fluid L from the exhaust gas using the gas-liquid separator 22, further stable operation of the device can be achieved.

### Seventh embodiment

The working fluid L of the diffusion pump 4 of a seventh embodiment adsorbs the gas by a chemical reaction with gas within the vacuum vessel.

The exhaust gas from the plasma is considered to contain water vapor, hydrocarbon, ammonia, and the like as water vapor or a tritiated compound. Since an alkali metal is chemically active, collision with such compound gases causes a chemical reaction. For example, by reduction of water vapor, these can be returned to a hydrogen isotope (deuterium, tritium), and gas after the reaction can be adsorbed.

According to the present embodiment, an exhaust effect can be improved by a chemical interaction between the alkali metal or liquid metal as the working fluid and the exhaust target gas.

### Eighth embodiment

The diffusion pump 4 of an eighth embodiment is installed inside the vacuum vessel or in a space adjacent thereto. In particular, the diffusion pump 4 is installed inside (specifically, at the lower portion of) the vacuum vessel of the nuclear fusion reactor or in a space adjacent thereto. The casing 11 may be common to a part of the vacuum vessel of the nuclear fusion reactor.

According to the present embodiment, a degree of freedom in the configuration of the vacuum vessel including the diffusion pump can be increased.

In the above description, an example has been described in which the base heater 16 or the side heater 19 provided on the outer wall of the lower portion of the casing 11 heats and evaporates the working fluid L stored in the working fluid reservoir 15. However, the working fluid L stored in the working fluid reservoir 15 may be heated by a heater other than the base heater 16 or the side heater 19 provided on the outer wall of the lower portion of the casing 11. That is, the heater that heats the working fluid L may be installed at a position other than a position where the base heater 16 or the side heater 19 provided on the outer wall of the lower portion of the casing 11 is installed with respect to the casing 11.

The working fluid L is preferably a liquid metal having a high vapor pressure and a low boiling point in order to operate the diffusion pump in a high-pressure environment. The working fluid L is, for example, preferably an alkali metal, an alkali metal alloy or another liquid metal having a relatively low boiling point and a high vapor pressure (for example, 100 Pa or more). The liquid metal having a low boiling point, that is, a low-boiling-point metal may be, for example, a metal having a boiling point at 1 atm (101.325 kPa) of less than 2950°C, preferably less than 2650°C, more preferably less than 1700°C, and still more preferably less than 1400°C. In addition, the low-boiling-point metal is preferably, for example, a metal having a boiling point at 1 atm of 400°C or higher. The alkali metal is preferably a metal having a boiling point at 1 atm of less than 1700°C, and more preferably less than 1400°C.

The low-boiling-point metal may be, for example, a metal having a boiling point at a vapor pressure of 100 Pa of less than 1850°C, preferably less than 1500°C, more preferably less than 1100°C, and still more preferably less than 750°C. In addition, the low-boiling-point metal is preferably, for example, a metal having a boiling point at a vapor pressure of 100 Pa of 150°C or higher. The alkali metal is preferably a metal having a boiling point at a vapor pressure of 100 Pa of less than 1100°C, and more preferably less than 750°C.

The low-boiling-point metal may be, for example, a metal having a boiling point at a vapor pressure of 1 Torr (133.332 Pa) of less than 1850°C, preferably less than 1500°C, more preferably less than 1100°C, and still more preferably less than 750°C. The low-boiling-point metal is preferably, for example, a metal having a boiling point at a vapor pressure of 1 Torr (133.332 Pa) of 150°C or higher. The alkali metal is preferably a metal having a boiling point at 1 Torr (133.332 Pa) of less than 1100°C, and more preferably less than 750°C.

The alkali metal that can be used as the working fluid L may be lithium (Li), sodium (Na), potassium (K), rubidium (Rb), cesium (Cs), francium (Fr), or an alloy thereof. The low-boiling-point metal other than the alkali metal that can be used as the working fluid L is preferably a metal other than mercury, and may be, for example, lead (Pb), indium (In), gallium (Ga), tin (Sn), or an alloy thereof.

In the fourth embodiment, the temperature adjustment pipe 18 is switchable between the cooling pipe and the heating pipe. Accordingly, the temperature adjustment pipe 18 can be operated as a cooling device that cools the inner wall side surface of the casing 11 to liquefy the vapor of the working fluid during operation, and can also be operated as a heating device upon startup. Here, the startup may be a period from when at least one of the base heater 16 or the side heater 19 provided on the outer wall of the lower portion of the casing 11 starts heating the working fluid L to when the evaporation of the working fluid L stored in the working fluid reservoir 15 starts. The operation may be a period during which gas molecules within the vacuum vessel are introduced into the casing 11 via the intake port 13.

The temperature adjustment pipe 18 may function as a cooling pipe by causing a cooling fluid to flow in the pipe. The temperature adjustment pipe 18 may function as a heating pipe by causing a heating fluid to flow in the pipe. The temperature adjustment pipe 18 may function as the heating pipe to heat the inner wall side surface of the casing 11 during a period from when at least one of the base heater 16 or the side heater 19 provided on the outer wall of the lower portion of the casing 11 starts heating the working fluid L to at least when the evaporation of the working fluid L starts, and then function as the cooling pipe to cool the inner wall side surface of the casing 11. The temperature adjustment pipe 18 may function as the heating pipe to heat the inner wall side surface of the casing 11 during the period from when at least one of the base heater 16 or the side heater 19 provided on the outer wall of the lower portion of the casing 11 starts heating the working fluid L to at least when the evaporation of the working fluid L starts, and then, in response to the start of the evaporation of the working fluid L, function as the cooling pipe to cool the inner wall side surface of the casing 11. The temperature adjustment pipe 18 may function as the heating pipe to heat the inner wall side surface of the casing 11 during the period from when at least one of the base heater 16 or the side heater 19 provided on the outer wall of the lower portion of the casing 11 starts heating the working fluid L to at least when the evaporation of the working fluid L starts, and then, in response to start of introduction of the gas molecules within the vacuum vessel into the casing 11 via the intake port 13, function as the cooling pipe to cool the inner wall side surface of the casing 11.

In the above description, an example has been described in which the jet nozzle 17 ejects the vapor of the working fluid L, which is heated by at least one of the base heater 16 or the side heater 19 provided on the outer wall of the lower portion of the casing 11 and thereby evaporated, in the downward direction, but the downward direction may be a direction including a component in a direction toward the bottom portion of the casing 11.

The above has been described based on some embodiments of the present invention. It is to be understood by those skilled in the art that these embodiments are exemplary and that various modifications and changes can be made within the scope of the claims of the present invention, and that such modifications and changes are also within the scope of the claims of the present invention. Accordingly, the description and drawings herein should be treated as illustrative rather than restrictive.

In the embodiments described above, a nuclear fusion reactor has been mainly employed as the vacuum vessel, and the gas to be exhausted has been the exhaust gas from plasma. However, the diffusion pump of the present disclosure is not limited thereto, and can be suitably applied to a wide range of fields such as aeronautics, aerospace engineering, particle accelerators, medical equipment, or precision machine manufacturing.

Any combination of the embodiments and modifications described above is also useful as an embodiment of the present invention. A new embodiment generated by the combination has the effect of each of the combined embodiments and modifications.

In understanding the technical idea obtained by abstracting the embodiments and the modifications, the technical idea should not be interpreted limited to the contents of the embodiments and the modifications. The embodiment and modifications described above are only specific examples, and many design changes such as changes, additions, or deletions of components can be made. In the embodiments, contents where such design changes are possible are emphasized with the notation "embodiment". However, it goes without saying that design changes are allowed even for contents without such notation.

### Other possible items

### Item 1

A diffusion pump which generates a vacuum in a vacuum vessel, including:

a casing;

a jet body which is installed inside the casing;

an intake port which is installed at an upper portion of the casing and connected to the vacuum vessel;

an exhaust port which is installed at a lower portion of the casing;

a working fluid reservoir which is installed at a bottom portion of the casing and stores a working fluid;

a jet nozzle which ejects vapor of the working fluid, which is heated by a heater and thereby evaporated, in a direction including a component in a direction toward the bottom portion of the casing; and

a temperature adjustment pipe which is installed to surround the casing, wherein

the working fluid is an alkali metal or a low-boiling-point liquid metal.

### Item 2

The diffusion pump according to item 1, including, as the heater, a base heater which is installed at a bottom portion of the working fluid reservoir and heats the working fluid.

### Item 3

The diffusion pump according to item 2, including a side heater on an outer wall of the jet body.

### Item 4

The diffusion pump according to item 2 or 3, including a thermal insulator above the jet body.

### Item 5

The diffusion pump according to item 1, wherein the temperature adjustment pipe is switchable between a cooling pipe and a heating pipe.

### Item 6

The diffusion pump according to item 5, wherein the temperature adjustment pipe functions as the heating pipe to heat an inner wall side surface of the casing during a period from when the heater starts heating the working fluid to at least when evaporation of the working fluid starts, and then functions as the cooling pipe to start cooling the inner wall side surface of the casing.

### Item 7

The diffusion pump according to item 1, including a recovery mechanism for thermal energy held by gas within the vacuum vessel.

### Item 8

The diffusion pump according to item 1, wherein gas within the vacuum vessel contains vapor or mist of liquid metal or powdery solid debris, and the working fluid has an affinity for the vapor or mist of liquid metal or the powdery solid debris.

### Item 9

The diffusion pump according to item 8, including a gas-liquid separator which separates liquid of the working fluid from the gas within the vacuum vessel.

### Item 10

The diffusion pump according to item 1, wherein the working fluid adsorbs gas within the vacuum vessel by a chemical reaction with the gas.

### Item 11

The diffusion pump according to item 1, wherein the diffusion pump is installed inside a vacuum vessel of a nuclear fusion reactor or in a space adjacent thereto.

### EXPLANATION OF REFERENCES

1: diffusion pump;

2: diffusion pump;

3: diffusion pump;

4: diffusion pump;

11: casing;

12: jet body;

13: intake port;

14: exhaust port;

15: working fluid reservoir;

16: base heater;

17: jet nozzle;

18: temperature adjustment pipe;

19: side heater;

20: thermal insulator;

21: baffle;

22: gas-liquid separator;

MFL: magnetic field line; and

L: working fluid.

What is claimed is:

1. A diffusion pump which generates a vacuum in a vacuum vessel, comprising:
a casing;
a jet body which is installed inside the casing;
an intake port which is installed at an upper portion of the casing and connected to the vacuum vessel;
an exhaust port which is installed at a lower portion of the casing;
a working fluid reservoir which is installed at a bottom portion of the casing and stores a working fluid;
a jet nozzle which ejects vapor of the working fluid, which is heated by a heater and thereby evaporated, in a direction including a component in a direction toward the bottom portion of the casing; and
a temperature adjustment pipe which is installed to surround the casing, wherein
the working fluid is an alkali metal or a low-boiling-point liquid metal.

2. The diffusion pump according to claim 1, comprising, as the heater, a base heater which is installed at a bottom portion of the working fluid reservoir and heats the working fluid.

3. The diffusion pump according to claim 2, comprising a side heater on an outer wall of the jet body.

4. The diffusion pump according to claim 2, comprising a thermal insulator above the jet body.

5. The diffusion pump according to claim 3, comprising a thermal insulator above the jet body.

6. The diffusion pump according to claim 1, wherein the temperature adjustment pipe is switchable between a cooling pipe and a heating pipe.

7. The diffusion pump according to claim 6, wherein the temperature adjustment pipe functions as the heating pipe to heat an inner wall side surface of the casing during a period from when the heater starts heating the working fluid to at least when evaporation of the working fluid starts, and then functions as the cooling pipe to start cooling the inner wall side surface of the casing.

8. The diffusion pump according to claim 2, wherein the temperature adjustment pipe is switchable between a cooling pipe and a heating pipe.

9. The diffusion pump according to claim 8, wherein the temperature adjustment pipe functions as the heating pipe to heat an inner wall side surface of the casing during a period from when the heater starts heating the working fluid to at least when evaporation of the working fluid starts, and then functions as the cooling pipe to start cooling the inner wall side surface of the casing.

10. The diffusion pump according to claim 3, wherein the temperature adjustment pipe is switchable between a cooling pipe and a heating pipe.

11. The diffusion pump according to claim 10, wherein the temperature adjustment pipe functions as the heating pipe to heat an inner wall side surface of the casing during a period from when the heater starts heating the working fluid to at least when evaporation of the working fluid starts, and then functions as the cooling pipe to start cooling the inner wall side surface of the casing.

12. The diffusion pump according to claim 4, wherein the temperature adjustment pipe is switchable between a cooling pipe and a heating pipe.

13. The diffusion pump according to claim 12, wherein the temperature adjustment pipe functions as the heating pipe to heat an inner wall side surface of the casing during a period from when the heater starts heating the working fluid to at least when evaporation of the working fluid starts, and then functions as the cooling pipe to start cooling the inner wall side surface of the casing.

14. The diffusion pump according to claim 1, comprising a recovery mechanism for thermal energy held by gas within the vacuum vessel.

15. The diffusion pump according to claim 1, wherein gas within the vacuum vessel contains vapor or mist of liquid metal or powdery solid debris, and the working fluid has an affinity for the vapor or mist of liquid metal or the powdery solid debris.

16. The diffusion pump according to claim 15, comprising a gas-liquid separator which separates liquid of the working fluid from the gas within the vacuum vessel.

17. The diffusion pump according to claim 1, wherein the working fluid adsorbs gas within the vacuum vessel by a chemical reaction with the gas.

18. The diffusion pump according to claim 1, wherein the diffusion pump is installed inside a vacuum vessel of a nuclear fusion reactor or in a space adjacent thereto.

19. The diffusion pump according to claim 2, wherein the diffusion pump is installed inside a vacuum vessel of a nuclear fusion reactor or in a space adjacent thereto.

20. The diffusion pump according to claim 3, wherein the diffusion pump is installed inside a vacuum vessel of a nuclear fusion reactor or in a space adjacent thereto.
